(19) United States
(12) Patent Application Publication
(10) Pub. No.: US 2014/0311715 A1
(43) Pub. Date: Oct. 23, 2014

(54) RADIATOR FAN ASSEMBLY

(71) Applicant: PROGRESS RAIL SERVICES CORPORATION, Albertville, AL (US)

(72) Inventor: Andrew M. Smith, Peoria, IL (US)

(73) Assignee: Progress Rail Services Corporation, Albertville, AL (US)

(21) Appl. No.: 13/866,781

(22) Filed: Apr. 19, 2013

(51) Int. Cl. F01P 5/02; F01P 11/00; B23P 11/00

(52) U.S. Cl. CPC F01P 5/02; B23P 11/00; F01P 11/00
USPC 165/121; 29/428

(57) ABSTRACT

A radiator fan for a locomotive is provided. The radiator fan includes a fan housing. The radiator fan further includes at least one bracket secured to the fan housing. The radiator fan is adapted to be installed and removed from a side of the locomotive by engagement with the at least one bracket.

### TECHNICAL FIELD

The present disclosure relates to a system and method for removably mounting a radiator fan, and more specifically for the installation or removal of the radiator fan from a locomotive.

### BACKGROUND

Usually, a locomotive employs a radiator core and a radiator fan to provide cooling for a power source and for electrical systems and components installed within an enclosure of the locomotive. In some designs, the radiator core is located on a roof section of the locomotive, while the radiator fan is located below the radiator core. In such arrangements, installation and removal of the radiator fan for servicing and replacement may be a complex process requiring significant effort and time. Moreover, the radiator core may also need to be partially or fully disassembled in order to provide sufficient access to the radiator fan.

Hence, there is a need for an improved design to provide ease of access to the radiator fan for the locomotive.

### SUMMARY OF THE DISCLOSURE

In one aspect of the present disclosure, a radiator fan for a locomotive is provided. The radiator fan includes a fan housing. The radiator fan further includes at least one bracket secured to the fan housing. The radiator fan is adapted to be installed and removed from a side of the locomotive by engagement with the at least one bracket.

In another aspect of the present disclosure, a method for accessing a radiator fan for a locomotive is provided. The method provides a fan housing. The method also provides at least one bracket secured to the fan housing. The method then engages, selectively, with the at least one bracket. The method further installs or removes the radiator fan from a side of the locomotive based on the engagement.

Other features and aspects of this disclosure will be apparent from the following description and the accompanying drawings.

### BRIEF DESCRIPTION OF THE DRAWINGS

FIG. 1 is an exemplary locomotive, according to one embodiment of the present disclosure;

FIG. 2 is a perspective view of a section of an enclosure of the locomotive shown in FIG. 1;

FIGS. 3 to 5 are different perspective views of an inside of the enclosure of the locomotive including a radiator fan, according to various embodiments of the disclosure; and

FIG. 6 is a method of installation or removal of the radiator fan.

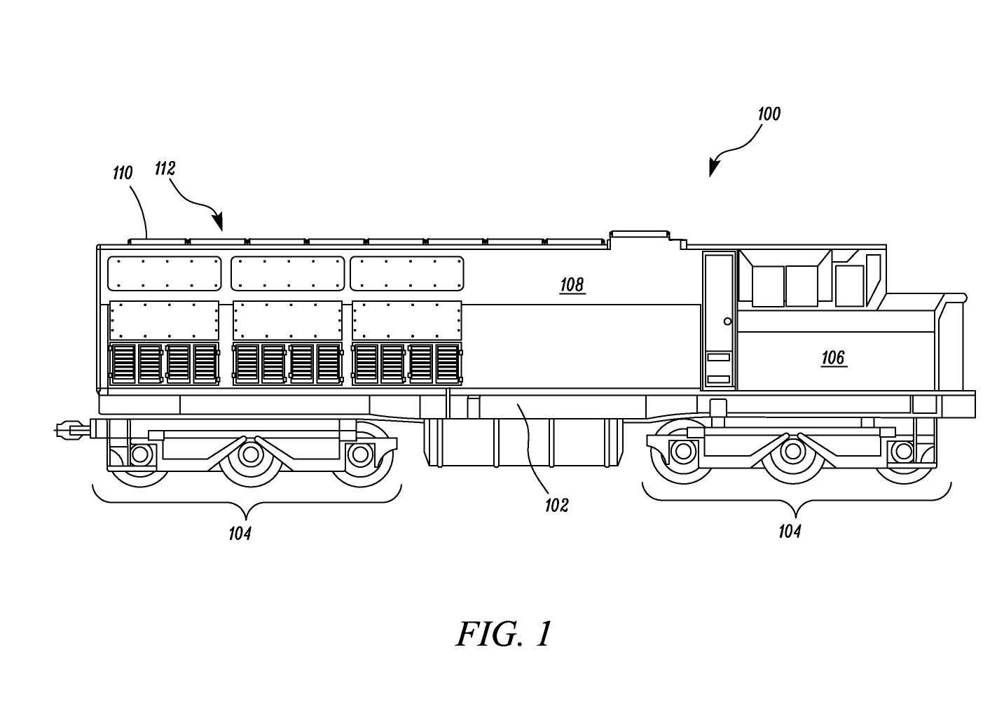

### DETAILED DESCRIPTION

Wherever possible, the same reference numbers will be used throughout the drawings to refer to the same or the like parts. FIG. 1 shows an exemplary locomotive 100, according to one embodiment of the present disclosure. It should be noted that the locomotive 100 may alternatively be any industrial machine related to, but not limited to, transportation, forestry, waste management, mining, construction, agriculture, material handling, and the like.

The locomotive 100 may include a frame or a chassis 102. A set of traction devices 104 may be coupled to the frame 102 to provide mobility to the locomotive 100. An operator cabin 106 may be provided on the frame 102. The operator cabin 106 may house various controls of the locomotive 100. An enclosure 108 may also be provided on the frame 102. The enclosure 108 may house various electrical and/or mechanical components of the locomotive 100. One such component may be a power source (not shown) which may be configured to provide power to the traction devices 104 and for other operational purposes of the locomotive 100.

The power source may be any one or a combination of an internal combustion engine, a gas turbine, a hybrid engine, power storage device like batteries, and so on. Alternatively, the power source may include any one, but not limited to, a refrigeration unit, a heating-ventilation-air conditioning (HVAC) unit, and the like. A cooling system may be provided to control and/or regulate a temperature associated with the power source.

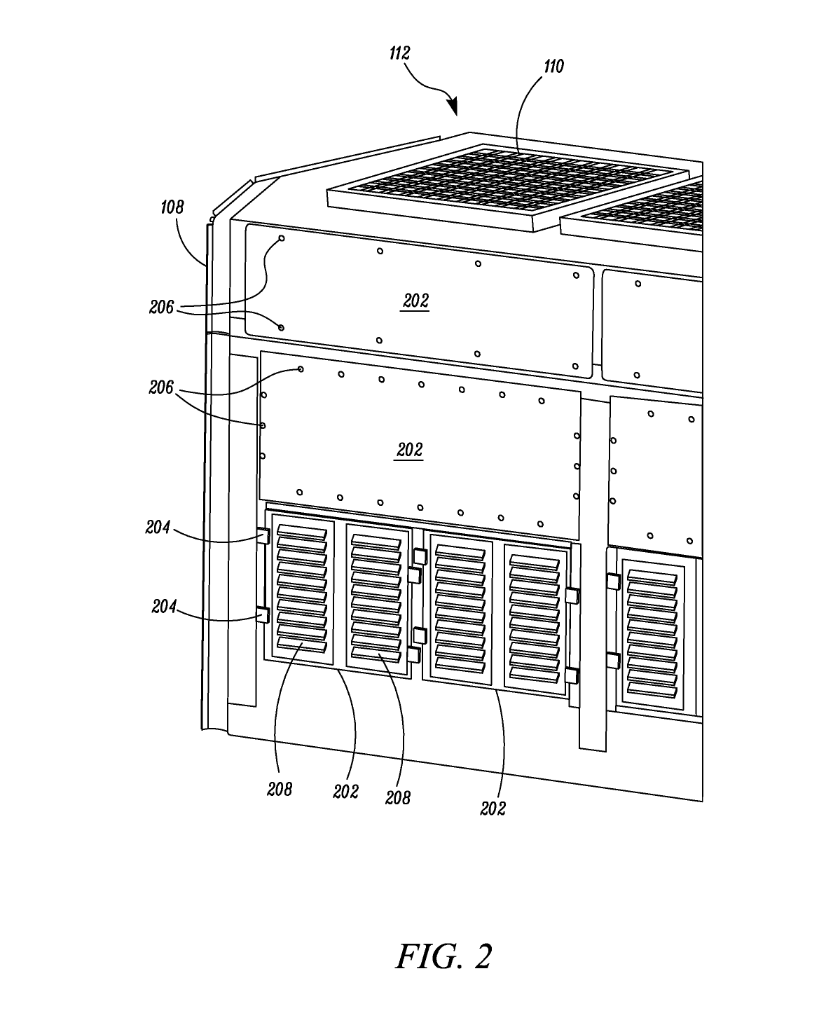

The cooling system may include a cooling jacket provided in association with the power source. A coolant may flow through the cooling jacket and may receive excess heat generated by the power source. The coolant may flow towards a radiator core 110 (see FIGS. 1 and 2), located proximate to a top surface 112 of the enclosure 108. In one embodiment, the radiator core 110 may be an arrangement of tubes placed parallel to each other in a spaced apart configuration. The design and structure of the radiator core 110 may vary based on the application. One of ordinary skill in the art will appreciate that the coolant may reject the excess heat of the power source to the atmosphere or other fluid while flowing through the radiator core 110. After rejecting the excess heat in the radiator core 110, the coolant may flow towards the power source to complete a cooling circuit.

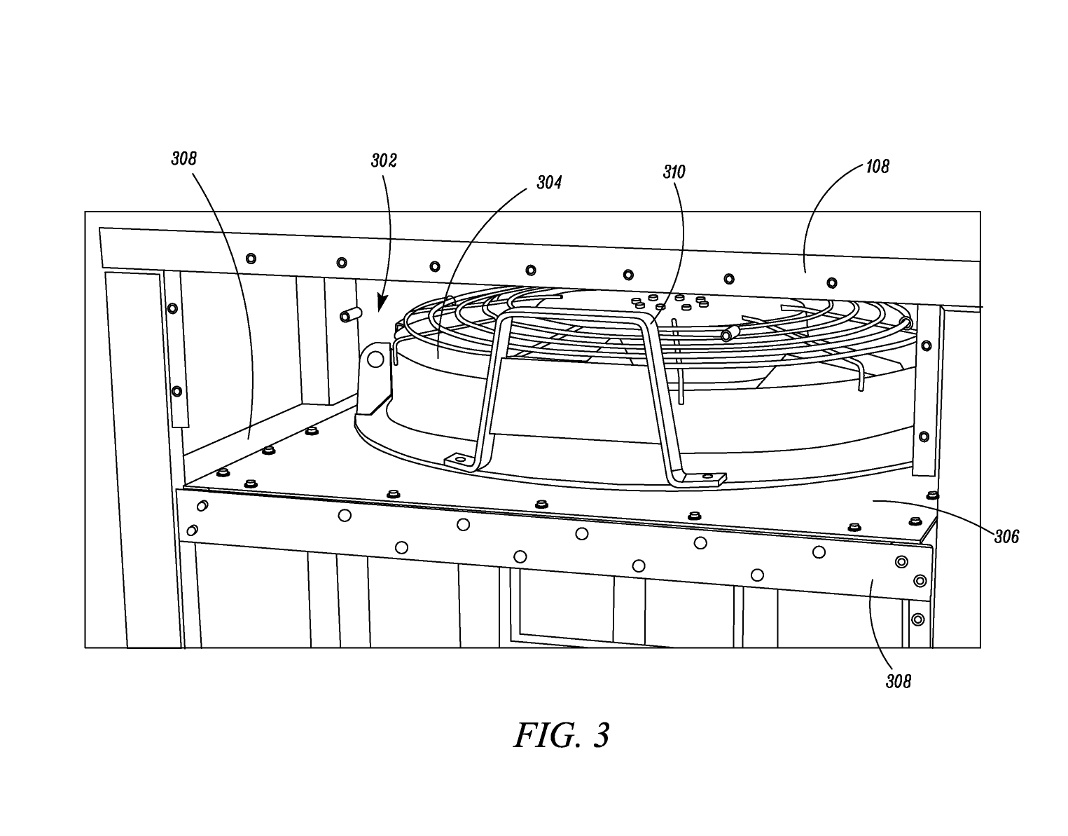

Referring to FIG. 3, the cooling system for the locomotive 100 may further include a radiator fan 302 that may be provided in association with the radiator core 110. The radiator fan 302 may provide a supply of air from below and through the radiator core 110 for cooling the radiator core 110. The radiator fan 302 may be mechanically or electrically driven. Further, parameters like size, number, position and orientation of the radiator fan 302 may vary as per system design and requirements.

In the present disclosure, access is provided to the radiator fan 302 from a side of the locomotive 100 for the purpose of installation or removal of the radiator fan 302, as the case may be. Accordingly, as shown in FIG. 2, the enclosure 108 may include a plurality of doors 202 positioned at the side of the locomotive 100 in order to provide access to the radiator fan 302 present inside the enclosure 108. In one embodiment, the door 202 may be affixed to the enclosure 108 using a suitable hinged configuration 204 known in the art. In another embodiment, a bolted configuration 206 may be used to affix the door 202 to the enclosure 108 by any one or a combination of suitable mechanical fasteners like bolts and nuts, screws, snapping arrangements, and so on. In yet another embodiment, at least part of the design of the door 202 may further include ventilators 208 in the form of any one or a combination of perforations, slots, grills, louvers, and the like in order to provide a supply of air for ventilation from an outside to the inside of the enclosure 108 and/or vice versa.

As shown in FIGS. 3 to 5, the radiator fan 302 may include a fan housing 304. The fan housing 304 may have a partially grilled configuration and may enclose a plurality of fan blades and/or electrical components associated with the radiator fan 302. The fan housing 304 may further include a plate extension 306 onto which the fan housing 304 is affixed. The plate extension 306 is configured to be removably affixed onto at least one shelf 308 using any known mechanical fasteners like bolts and nuts, screws, snapping arrangements, and so on. It should be noted that the fan housing 304 described herein is merely exemplary and may be modified as per system design and requirements.

As shown in the illustrated embodiments, the radiator fan 302 may be positioned in a substantially horizontal orientation within the enclosure 108, with respect to the frame 102 of the locomotive 100. Moreover, the radiator fan 302 may be positioned proximate to the door 202 for ease of access to the radiator fan 302. It should be noted that in other embodiments, the radiator fan 302 may be removably installed in a substantially vertical or inclined orientation within the enclosure 108, with respect to the frame 102 of the locomotive 100 based on the positioning of the radiator core 110, without deviating from the scope of the present disclosure.

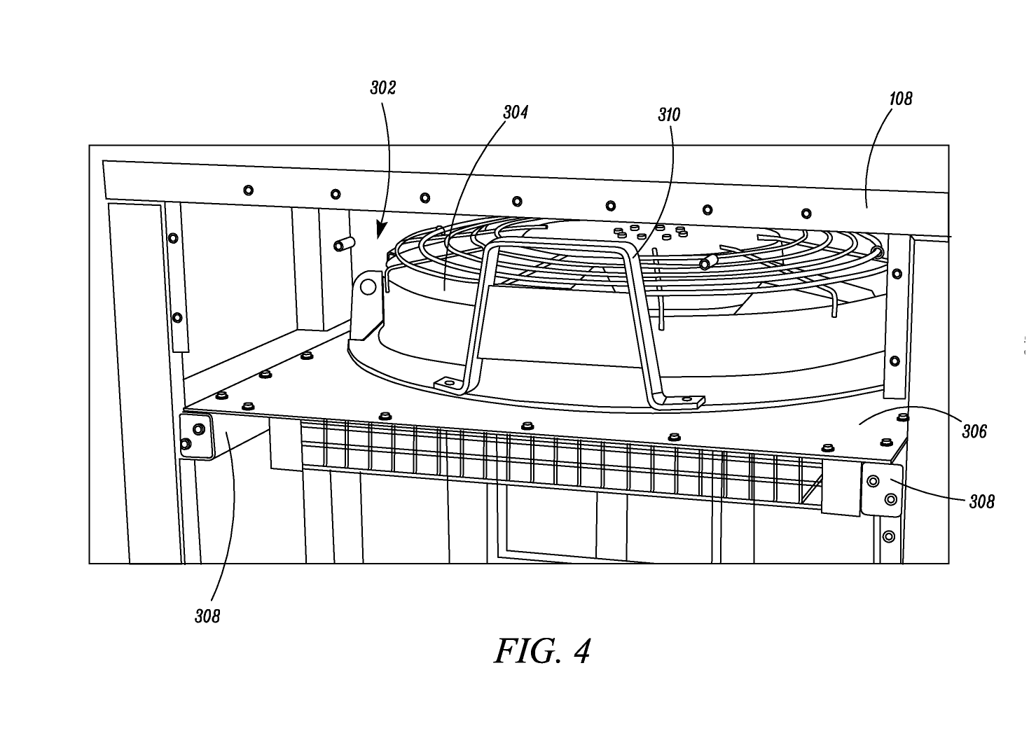

Further, the radiator fan 302 may be removably mounted on the at least one shelf 308 provided within the enclosure 108. In one embodiment, as shown in FIGS. 3 and 4, the shelf 308 may have a rod like configuration. For example, the rod like configuration may include an arrangement of horizontal, vertical and/or inclined structural members including, but not limited to, rods, bars, tubes, channels, beams and the like. The structural members may be made of metal or any known polymer. In the illustrated embodiments, four shelves 308 are provided in cooperation with each other in a substantially horizontal orientation. The radiator fan 302 may be mounted on the arrangement of the shelves 308. Alternatively, the at least one shelf 308 may have a substantially planar or sheet like configuration.

Additionally, the radiator fan 302 may be provided with at least one bracket 310 secured to the fan housing 304. The bracket 310 may be provided as an integral part of the fan housing 304 or may be additionally affixed to the fan housing 304. In one embodiment, the bracket 310 may have an inverted “U” shaped configuration. In another embodiment, the bracket 310 may have an inverted “L” shaped configuration or any other suitable configuration. The bracket 310 may extend vertically above the fan housing 304 so as to provide sufficient space around the bracket 310 for an operator to hold the bracket 310 or to allow a tool of a lifting machine to pass through the bracket 310 without interfering with the fan housing 304. In the illustrated embodiment, a pair of brackets 310 is provided in a spaced apart arrangement from each other. The pair of brackets 310 is secured to the fan housing 304 in a substantially same plane. It should be noted that parameters like size, number, position and orientation of the bracket 310 may vary as per system design and requirements.

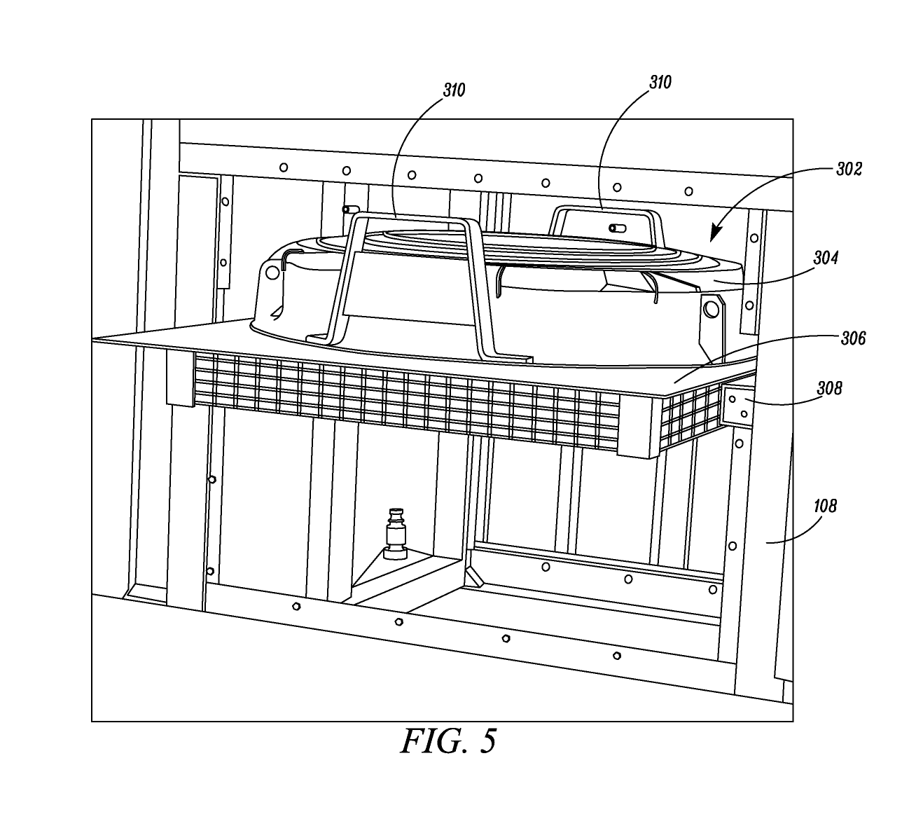

The bracket 310 may be configured to removably install the radiator fan 302 from the shelf 308 within the enclosure 108. For example, as shown in FIG. 5, the bracket 310 may function as a handle to enable the operator to hold and displace the radiator fan 302 by lifting and/or sliding the radiator fan 302 into or out of the enclosure 108 during the installation and removal, respectively.

### INDUSTRIAL APPLICABILITY

In some locomotive designs, the radiator core is positioned at the top surface of the enclosure of the locomotive. Further, the radiator fan is installed below the radiator core to provide a supply of air through the radiator core for cooling of the radiator core. In such an arrangement, access to the radiator fan for servicing and/or replacement may be complex requiring significant effort and time.

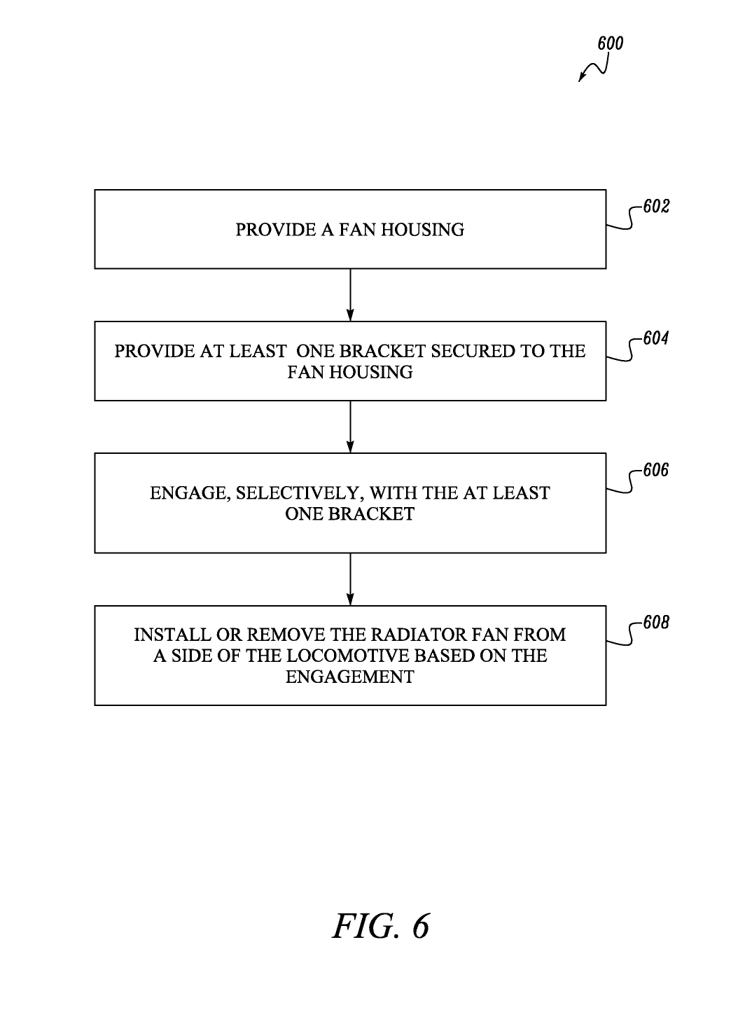

The present disclosure relates to a system and method for removably mounting the radiator fan 302 from the side of the locomotive 100. FIG. 6 is a method 600 for the installation or removal of the radiator fan 302. At step 602, the radiator fan 302 with the fan housing 304 is provided within the enclosure 108. At step 604, the bracket 310 may be secured to the fan housing 304. The door 202 provided at the side of the locomotive 100 may be unbolted or pivoted about the hinged configuration 204 to provide access to the radiator fan 302.

At step 606, the bracket 310 may be selectively engaged to install or uninstall the radiator fan 302 from within the enclosure 108. For example, the bracket 310 may be used as the handle by the operator to displace the radiator fan 302 from the position below the radiator core 110. For the large sized radiator fan 302, a suitable tool of a forklift or a crane or a similar lifting machine may be coupled to the bracket 310 to displace the radiator fan 302 from the position below the radiator core 110. Selective engagement with the bracket 310 may further involve sliding, lifting and displacing the radiator fan 302 from within the enclosure 108, during the removal operation. At step 608, the radiator fan 302 can either be installed or removed from the side of the locomotive 100 based on the engagement. It should be noted that the engagement may facilitate access to the radiator fan 302 without disturbing an arrangement of the radiator core 110.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A radiator fan for a locomotive, the radiator fan comprising:
a fan housing; and
at least one bracket secured to the fan housing;
wherein the radiator fan is adapted to be installed and removed from a side of the locomotive by engagement with the at least one bracket.

2. The radiator fan of claim 1 further comprising a shelf, wherein the radiator fan is removably mounted on the shelf

3. The radiator fan of claim 1 further comprising at least one door provided on the side of the locomotive.

4. The radiator fan of claim 3, wherein the at least one door has a hinged configuration or a bolted configuration.

5. The radiator fan of claim 1, wherein a pair of the brackets is provided in a spaced apart arrangement from each other and is secured atop the radiator fan in a substantially same plane.

6. A method for accessing a radiator fan for a locomotive, the method comprising:
providing a fan housing;
providing at least one bracket secured to the fan housing;
engaging, selectively, with the at least one bracket; and
installing or removing the radiator fan from a side of the locomotive based on the engagement.

7. The method of claim 6 further comprising providing at least one door on the side of the locomotive.

8. A locomotive comprising:
a power source;
a frame;
at least one radiator fan comprising:
a fan housing; and
at least one bracket secured to the fan housing;
wherein the at least one radiator fan is adapted to be installed and removed from a side of the locomotive by engagement with the at least one bracket.

9. The locomotive of claim 8 further comprising a shelf, wherein the radiator fan is removably mounted on the shelf

10. The locomotive of claim 8 further comprising at least one door provided on the side of the locomotive.

11. The locomotive of claim 10, wherein the at least one door has a hinged configuration or a bolted configuration.

12. The locomotive of claim 8, wherein a pair of the brackets is provided in a spaced apart arrangement from each other and is secured atop the radiator fan in a substantially same plane.
